(19) United States
(12) Patent Application Publication
(10) Pub. No.: US 2011/0010451 A1
(43) Pub. Date: Jan. 13, 2011

(54) Handheld Media Device For Displaying Computer Status Information

(76) Inventors: Thomas H. Szolyga, Saratoga, CA (US); Ashwin V. Lodhia, Mountain View, CA (US); Mark C. Solomon, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/919,290

(22) PCT Filed: Mar. 13, 2008
(86) PCT No.: PCT/US08/56822

§ 371 Date: Aug. 25, 2010

(51) Int. Cl. G06F 15/173

(52) U.S. Cl. 709/224

(57) ABSTRACT

A system comprises a personal computer (PC) and a handheld media device (HMD) communicably coupled to the PC. The PC transfers status information to the HMD and the HMD displays the status information. The HMD is capable of displaying the status information using at least one of graphics or text. The status information includes information pertaining to the status the PC.

### BACKGROUND

A computer system generally comprises a main display by which a user of the system is provided with visual information. For example, the display may be used for various multimedia applications (e.g., to watch movies, play games), for word processing applications (e.g., to read text), etc. In some cases, the user may desire to view additional information beyond what is already displayed on the display. However, the user may want to refrain from disturbing the information already displayed on the display.

### BRIEF DESCRIPTION OF THE DRAWINGS

For a detailed description of exemplary embodiments of the invention, reference will now be made to the accompanying drawings in which:

FIGS. 1a-1c show illustrative systems implementing the device disclosed herein, in accordance with various embodiments;

FIGS. 2a-2c show detailed views of the device of FIGS. 1a-1c, in accordance with various embodiments;

FIG. 2d shows an illustrative, detailed view of the systems of FIGS. 1a-1c, in accordance with various embodiments; and

FIG. 3 shows a flow diagram of an illustrative method implemented in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. A “handheld” device is a device that may be held in a user's hand during use. A “personal computer” is any computer suitable for personal use, such as a desktop computer, a laptop computer, a notebook computer, etc. In some embodiments, a personal computer may be a handheld device.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

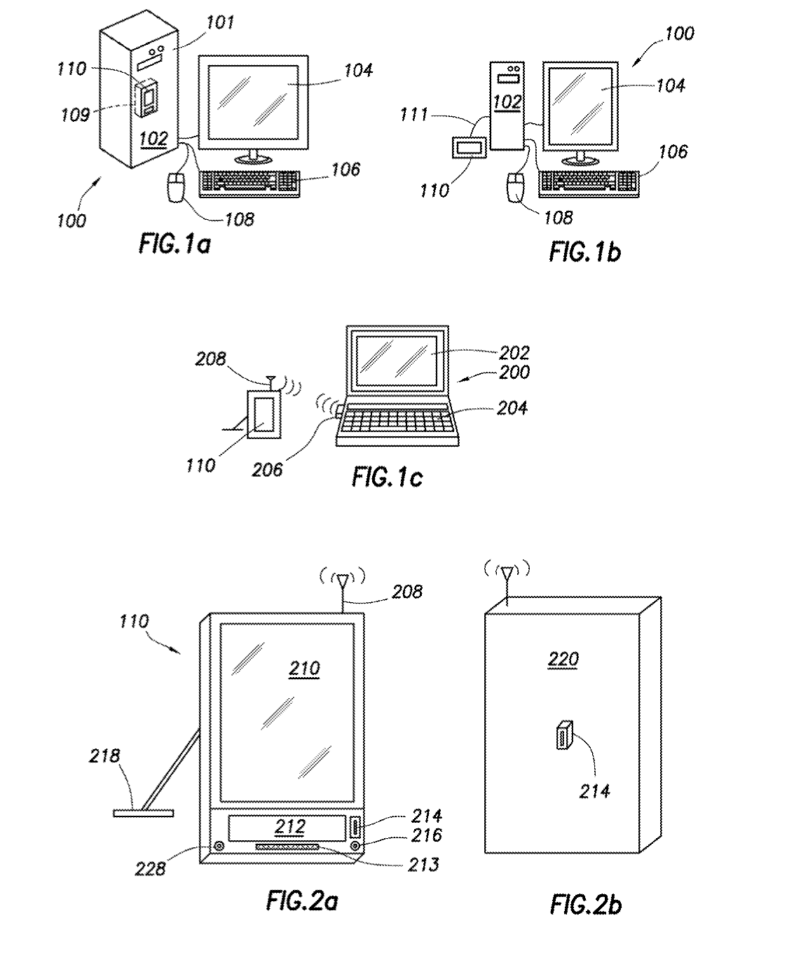

Disclosed herein are various embodiments of a portable display device (PDD) (e.g., a handheld media device) usable to display information associated with a separate computer system. FIG. 1a shows an illustrative computer system (e.g., personal computer (PC)) 100. The computer system 100 comprises a chassis (e.g., mini-tower) 102 that houses various hardware, including processors, memory, etc. The chassis 102 couples to a display 104 (e.g., a Liquid Crystal Display (LCD), Cathode Ray Tube (CRT), 12″ and larger) and input devices such as a keyboard 106 and a mouse 108. FIG. 1a also shows an illustrative PDD 110 removably coupled to the chassis 102. The PDD 110 couples to the chassis 102 by way of any suitable mechanism, such as a Universal Serial Bus (USB) connection, described below. In accordance with various embodiments, when the display 104 is displaying information and a user of the system 100 desires to view information pertaining to the system 100 without disturbing the information being displayed on the display 104, logic inside the chassis 102 may transfer the desired information to the PDD 110 for display. In turn, the PDD 110 may receives and displays the desired information. For example, a user may be playing a video game on the computer system 100. It would be helpful to the user to know information about the system 100 during game play, such as memory consumption information, processor performance information, temperature, processor utilization rate, etc. However, the user may wish to obtain such information without disturbing gameplay. In such cases, logic inside the chassis 102 may automatically transfer this information to the PDD 110 for display. Thus, the user is able to view the desired information on the PDD 110 without disturbing gameplay on the display 104. The information may be displayed on the PDD 110 even if there is no information being displayed on the display 104, or if there is no information on the display 104 that cannot be disturbed.

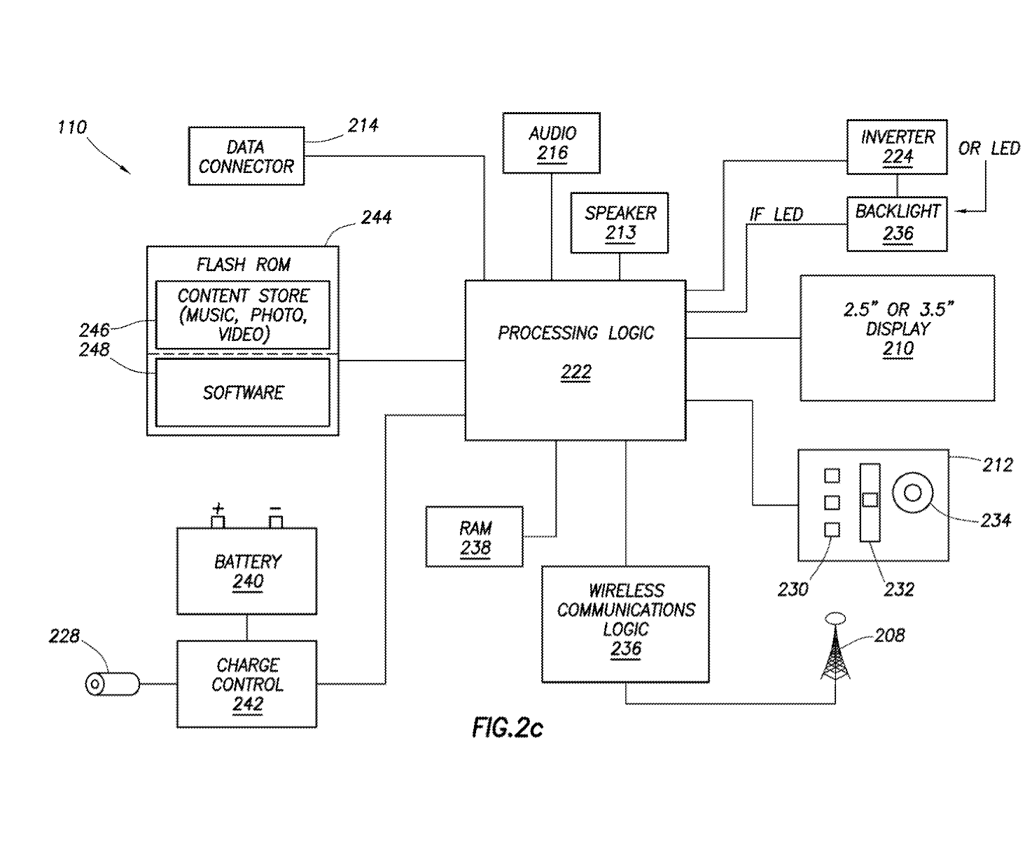

As explained above, the PDD 110 may couple to the chassis 102 via a USB connection. In some embodiments and as shown in FIG. 1a, this connection is a blind-mating connection, whereby a user inserts the PDD 110 into a cavity 109 in the chassis 102 such that a USB connector (shown in FIG. 2b) on the PDD 110 couples (blind-mates) to another USB connector on the chassis 102. In this way, the PDD 110 is housed within the cavity so that the surface of the PDD 110 having the display is flush or is substantially flush (e.g., within 2 cm) with the surface 101 of the chassis 102. In at least some embodiments, the chassis 102 comprises a sliding cover (not specifically shown) that can mask or hide the cavity 109 when the PDD 110 is not coupled to the chassis 102 or, in some cases, even if the PDD 110 is coupled to the chassis 102. In some embodiments, the connection between the PDD 110 and the chassis 102 is a wired connection, such as that shown in FIG. 1b. FIG. 1b shows the system 100 of FIG. 1a, except that the PDD 110 couples to the chassis 102 not through a blind-mating connection, but via a USB cable 111.

In addition to the blind-mating and wired connections shown in FIGS. 1a and 1b, other types of connections also may be possible. For example, as shown in FIG. 1c, a computer system 200 (e.g., a notebook or laptop computer) comprising a display 202, keyboard 204 and wireless card 206 may wirelessly communicate with the PDD 110 via an antenna 208. In some embodiments, the antenna 208 is retractable, meaning that the antenna 208 may be fully housed within the chassis of the PDD 110 when not being used. Any suitable wireless communication protocol, such as the BLUETOOTH® protocol, IEEE® 802.xx protocol, etc. may be used.

Although the PDD 110 and the chassis 102 are shown as being physically connected in FIGS. 1a-1b, in some embodiments, the chassis 102 and the PDD 110 may communicate wirelessly, as illustrated in FIG. 1c. Similarly, although the PDD 110 and the computer system 200 are shown to be communicating wirelessly in FIG. 1c, in some embodiments, the PDD 110 and the computer system 200 may be physically connected (e.g., blind-mating, USB cables). In at least some embodiments, the PDD 110 is “hot-pluggable” to computer systems.

FIG. 2a shows a detailed view of an illustrative PDD 110. Besides the antenna 208, the PDD 110 comprises a display 210 (e.g., a liquid crystal display (LCD)), an input panel 212, a speaker 213, a data connector 214, an audio jack 216, a stand 218 and a power jack 228. The display 210 may be of any suitable size, although in some embodiments, the display size ranges between 2.5 inches and 3.5 inches. In any case, the display 210 is significantly smaller than (e.g., less than 1/10 the size of) the displays 104 and 202. The input panel 212 comprises various input mechanisms (e.g., keys/buttons, scroll bars, scroll wheels, sliders, touch-sensitive devices, light-sensitive devices) by which a user of the PDD 110 may interact with the PDD 110. The data connector 214 supports wired connections (e.g., USB connections) to other electronic devices (e.g., a computer system). The audio jack 216 may couple to a pair of headphones (e.g., to output music). The power jack 228 couples to a power source, such as a wall outlet, whereby a battery housed within the PDD 110 may be recharged. The stand 218 enables the PDD 110 to stand upright or at an angle when the PDD 110 is placed on a surface, such as a desk.

In some embodiments, the data connector 214 may be in a different location than that shown in FIG. 2a. For example, as explained above, the PDD 110 may be blind-mated to a computer system. To facilitate such blind-mating, in some embodiments, the data connector 214 is located on a rear surface 220 of the PDD 110, as shown in FIG. 2b. In this way, the PDD 110 may be blind-mated to a complementary connector on a computer system, as described above in reference to FIG. 1a.

FIG. 2c shows a block diagram of circuit logic housed within the PDD 110. The PDD 110 comprises processing logic 222 and an inverter 224 and a backlight 226 that are used to assist the display 210 in displaying images. The PDD 110 also comprises the input panel 212 having buttons 230, slider 232 and wheel 234 (although in some embodiments, the input panel 212 has fewer or more input devices, or has different input devices). The PDD 110 further comprises wireless communication logic 236 (e.g., BLUETOOTH® logic), the antenna 208, random access memory (RAM) 238, a battery 240 coupled to a charge control device 242 and the power jack 228 (e.g., direct current (DC) input), read-only memory (ROM) 244 (e.g., flash ROM) comprising content 246 (e.g., music, MP3 files, photos, videos) and software 248, the data connector 214, the speaker 213 and the audio jack 216. Other logic also may be included.

In operation, the processing logic 222 receives information from various sources and outputs information accordingly. For example, still referring to FIG. 2c, the processing logic 222 may receive information from another electronic device (e.g., a computer system) via the data connector 214 or the antenna 208 and wireless communication logic 236. In turn, the processing logic 222 may output the information to the display 210, to the audio jack 216 or to the speaker 213. The processing logic 222 also may store the information to the RAM 238 or to other storage not specifically shown. The processing logic 222 also may receive information from the input panel 212. For example, a user of the PDD 110 may use the input panel and the display 210 to select a music file, photo, etc. of content 246 in the ROM 244 to be played or displayed. Accordingly, the processing logic 222 retrieves the selected content 246 from the ROM 244 and outputs the content as necessary (e.g., plays the music via audio jack 216 and/or speaker 213, display the photo on the display 210). Thus, the PDD 110 may be considered to be a portable, digital, multimedia device. The processing logic 222 also may obtain information from the ROM 244 or RAM 238 and transfer the information to another electronic device via the data connector 214 or the wireless communication logic 236, or may receive information from the data connector 214 or the wireless communication logic 236 and may store the received information to the RAM 238 or other suitable storage. Further, in some embodiments, information received from the data connector 214 and/or the wireless communication logic 236 may be routed directly to the display 210 for display and/or to the audio jack 216 or speaker 213 for audible output.

FIG. 2d shows an illustrative block diagram of circuit logic 250 housed within the chassis 102 (FIGS. 1a-1b) or within the computer system 200 (FIG. 1c). The circuit logic 250 comprises processing logic 252, ROM 256 comprising software 258, RAM 260, wireless communication logic 262 coupled to an antenna 264 and input/output (I/O) ports 266.

Referring to both FIGS. 2c and 2d, a user may be using the computer system (e.g., computer system 100 or 200) such that the user does not want to disturb whatever information is being displayed on the computer system's display (e.g., display 104 or 202). However, the user still may want to see other information selected from categories such as central processing unit (CPU) utilization, CPU temperature, graphics processor utilization, graphics processor temperature, memory utilization, disk capacity remaining, network throughput, etc. Accordingly, the processing logic 252 may execute the software 258 (e.g., upon the click of a mouse or a key on a keypad, upon the execution of a predetermined application such as a video game, upon boot-up). Execution of the software 258 may cause the processing logic 252 to collect desired information from the computer system. The desired categories of information, such as the categories listed above, may be predetermined by the user and may be preprogrammed into the RAM 260, the RAM 238, or other suitable storage. The user also may specify how the user wishes to see the information displayed (e.g., graphics, text, both). The user may preprogram this information using, for example, the software application 258, the software 248 or some other suitable utility. In this way, the software 258 and processing logic 252 “know” what kind of information the user desires to see on the PDD 110 and how the user desires to see it. Upon collecting the desired information from various components of the computer system (e.g., internal software status tables stored in memory or internal hardware registers), the software 258 causes the processing logic 252 to transfer the information to the PDD 110. The information may be transmitted wirelessly (e.g., using the wireless communication logic 262) or via a physical connection (e.g., via I/O 266), such as a USB connection.

In turn, the processing logic 222 of the PDD 110 executes software 248 which causes the processing logic 222 to receive the information from the computer system via the wireless communication logic 236 or the data connector 214. Upon receiving the desired information, the processing logic 222 displays the information on the display 210. The display of information may be in any suitable format, such as text, graphics (e.g., graphics, charts, meters) or a combination thereof. Alternatively, or in addition, the processing logic 222 may store the desired information on the RAM 238, may play the desired information in audible form via the audio jack 216 or speaker 213, and/or may transfer the information to another electronic device via the wireless communication logic 236 or the data connector 214. In this way, the user is able to view the desired information on the PDD 110 without disturbing the information being displayed on the computer system display.

Information transferred to the PDD 110 may be displayed in any suitable format, such as graphics, text or both. For example, the PDD 110 may receive a number indicating the temperature of a processor in the chassis 102. The PDD 110 may display the number itself or may display a graphical depiction of the number (e.g., on a chart, graph, meter). Further, the PDD 110 may be preprogrammed with, or may receive with the number, a threshold value against which the number should be compared. If the number meets or exceeds the threshold value, an alert may sound on the PDD 110. For example, if a processor temperature is 80 degrees and the threshold temperature is 75 degrees, the PDD 110 may sound an audible alarm or may display an alert in the form of flashing lights, specific graphics, etc.

In at least some embodiments, the desired information is displayed on the PDD 110 using the MICROSOFT® VISTA® operating system and, in particular, using the SIDESHOW® and/or GADGETS® features. This technique, as described below, is advantageous at least because it provides a parallel information processing path to present diagnostic or information data to the end-user. Thus, if the VISTA® operating system fails, the PDD 110 is still able to present the data to the end-user.

For example, in operation, the software application 258 in FIG. 2d may comprise an operating system (such as the MICROSOFT® VISTA® operating system) or at least may comprise software running under such an operating system. The software application 258 gathers the required information/parameters from internal software status tables (e.g., that can be stored in ROM 256 or RAM 260) or hardware registers (not shown). The software 258 then sends this information to the PDD 110. In turn, the POD 110 formats and presents the information to the end-user using, e.g., the software 248.

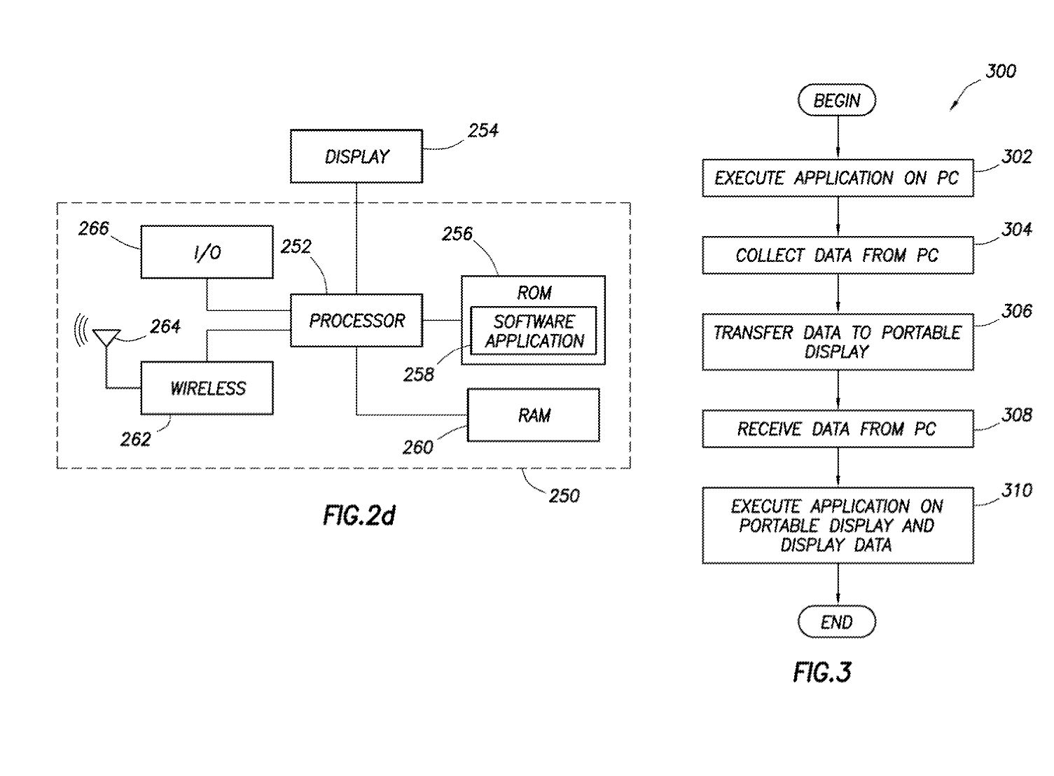

Other information paths, such as the Enthusiast System Architecture (ESA), also may be used. The ESA is a universal serial bus (USB)-based network internal to the chassis 102 of FIGS. 1 and 2 or the computer 200 of FIG. 3. The ESA couples to components such as power supplies, liquid cooling systems, fan controllers, lighting controllers, etc. Through the ESA, the processor 252 may collect additional information such as the power supply output voltage levels, current, or temperature or the liquid cooling system's coolant temperature, etc. The scope of this disclosure encompasses any and all such variations.

FIG. 3 shows a flow diagram of an illustrative method 300 implemented in accordance with various embodiments. The method 300 comprises executing an application on a computer system (block 302). The method 300 also comprises collecting desired information on the computer system (block 304). The method 300 then comprises transferring the data to the PDD (block 306). The method 300 further comprises receiving the data from the computer system (block 308) and executing an application on the PDD that causes the PDD to display the desired information (block 310).

In some embodiments, the PDD 110 does not comprise a cell phone, although in some embodiments, the PDD 110 may comprise a cell phone. In some embodiments, the PDD 110 does not comprise a personal digital assistant (PDA), although in some embodiments, the PDD 110 may comprise a PDA. In some embodiments, the PDD 110 does not comprise an APPLE® iPOD®, although in some embodiments, the PDD 110 may comprise an APPLE® iPOD®.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a personal computer (PC); and
a handheld media device (HMD) communicably coupled to the PC;
wherein the PC transfers status information to the HMD and the HMD displays said status information, said HMD capable of displaying said status information using at least one of graphics or text;
wherein the status information includes information pertaining to the status of the PC.

2. The system of claim 1, wherein said status information is of multiple types, said types of status information specified by an end-user and stored on said PC before the PC collects the status information.

3. The system of claim 1, wherein the HMD wirelessly couples to the PC.

4. The system of claim 1, wherein the HMD uses a MICROSOFT® SIDESHOW® feature and/or a MICROSOFT® GADGETS® feature to display said status information.

5. The system of claim 1, wherein the HMD is capable of storing and playing music files, video files or music files and video files.

6. The system of claim 1, wherein the HMD is hot-pluggable to the PC.

7. The system of claim 1, wherein the HMD and the PC couple together using blind-mating connectors.

8. The system of claim 1, wherein the status information comprises information selected from the group consisting of central processing unit (CPU) utilization, CPU temperature, graphics processor utilization, graphics processor temperature, memory utilization, disk capacity remaining and network throughput.

9. The system of claim 1, wherein the HMD is battery-operated and is capable of playing music files and video files when not coupled to the PC.

10. A device, comprising:
processing logic; and
a display;
wherein the processing logic receives status information of hardware of a personal computer and displays the status information on the display in at least one of a graphical format or a textual format;
wherein the device comprises a handheld media device.

11. The device of claim 10, wherein the device comprises a Universal Serial Bus (USB) connector on a surface of the device, said USB connector adapted to be blind-mated to said personal computer.

12. The device of claim 10, wherein the device receives said status information from the personal computer wirelessly.

13. The device of claim 10, wherein the device comprises storage that stores music files, photo files and video files.

14. The device of claim 10, wherein the processing logic uses a MICROSOFT® SIDESHOW® feature, a MICROSOFT® GADGETS® feature, or a combination of SIDESHOW® and GADGETS® features to display the status information on said display.

15. The device of claim 10, wherein the status information comprises one or more items of information selected from the group consisting of central processing unit (CPU) utilization, CPU temperature, graphics processor utilization, graphics processor temperature, memory utilization, disk capacity remaining and network throughput.

16. The device of claim 10, wherein the device comprises a stand that enables the device to be positioned upright.

17. A method, comprising:
programming a first computer with a category of information pertaining to hardware stored in said first computer;
collecting information associated with said category;
transferring said information from the first computer to a second computer;
receiving said information on the second computer; and
displaying said information on the second computer;
wherein the second computer comprises a portable, digital media device.

18. The method of claim 17, wherein collecting said information comprises collecting said information only after receiving an authorization from an end-user of the first computer or after starting execution of a predetermined application.

19. The method of claim 17 further comprising blind-mating a Universal Serial Bus (USB) connector of the second computer to another USB connector of the first computer.

20. The method of claim 19, wherein said blind-mating comprises installing the second computer into a cavity of the first computer so that a surface of the second computer comprising a display is flush with a surface of the first computer or is within 2 centimeters of being flush with said surface of the first computer.
